(19) United States
(12) Patent Application Publication
(10) Pub. No.: US 2025/0127348 A1
(43) Pub. Date: Apr. 24, 2025

(54) Automated Self-Cleaning Skylight

(71) Applicants: Tanaphat Leeruangariya, Bansuan (TH); WINWALL ALUMINIUM COMPANY LIMITED, Bangnamjeud (TH)

(72) Inventor: Tanaphat Leeruangariya, Bansuan (TH)

(73) Assignees: Tanaphat Leeruangariya, Bansuan (TH); WINWALL ALUMINIUM COMPANY LIMITED, Bangnamjeud (TH)

(21) Appl. No.: 18/736,551

(22) Filed: Jun. 7, 2024

(30) Foreign Application Priority Data
Oct. 24, 2023 (TH) 2303003117

(51) Int. Cl. A47L 1/02; B08B 1/16; B08B 1/30; B08B 1/40; E04D 13/03

(52) U.S. Cl. CPC A47L 1/02; B08B 1/165; B08B 1/30; B08B 1/40; A47L 2201/06; E04D 13/0305

(57) ABSTRACT

Provided is an automated self-cleaning skylight including a frame (1) fitted with glass (2) and installed with guide rails (3) on both sides of the frame that guides a wiper beam (12) consisting of wiper blade guide plates (9) and driven by a motor (4) with both sides being connected to shafts (5), wherein at opposite corners of the frame are located with spray nozzles (13) via which a cleaning solution is sprayed, and one side of the shafts is connected to a rotating pulley (6) that connects to a drive belt (8) connected to a tension pulley (7). When the shaft is rotated by the motor, the rotating pulley and the tension pulley are in turn rotated, causing the drive belt to shift and drive the wiper blade guide plates attached to the drive belt and a wiper blade (17) inserted into a groove in the wiper beam.

### CROSS-REFERENCE TO RELATED APPLICATIONS

This application claims priority of Provisional Application in Thailand No. 2303003117, filed on Oct. 24, 2023, the content of which is incorporated herein in its entirety by reference.

### FIELD OF THE INVENTION

Engineering relating to automated self-cleaning skylight.

### BACKGROUND OF THE INVENTION

Skylight windows are windows, installed on roof or any sidewall of house or building to admit natural light. To maintain optimum light transmittance and usage of said skylight, cleaning and removal of dust, pollutants, leaves, and organic substances are required to prevent the glass from becoming opaque which restricts light passing through properly and constantly. The cleaning processes typically require manual labor using a sponge or soft cloth with a non-corrosive cleaning solution to remove dust, pollutants, leaves, and organic substances.

Thai invention patent application No. 1201003185 filed Jun. 26, 2012, under the title ‘Automatic solar cell cleaning device’ was found. Wherein cleaning device is fixed to solar cell supporting frame. The device has slidable beam comprising steel beam attached to chain for sliding movement in left and right direction on shaft. Distance of the movement were determined by upper and lower limit switch and driving of transmission chain from the motor. Operation sequences were controlled by program installed in the controller. Art relating to cleaning by using wiper and drain which are attached to slidable beam was also disclosed. Drain is PVC tube that were linearly perforated, parallel with the slidable beam. The drain acts as a main device of the cleaner for discharging water and dust off the dust that covered on the surface and the pressure of the wipe that contact the solar cell were adjusted by way of securing wiper to the beam with spring as a connector, so that the pressure is not too high to prevent damage to the solar cell. Wherein the said invention disclosed the art that solved the problem concerning the improvement of solar cell cleaning wiper appearance that is smooth and curved, differ from appearance of surface of skylight windows which is flat throughout the whole part. Therefore, spring is not required to connect wiper to the slidable beam.

Thai invention patent application No. 1601000157 filed Jan. 13, 2016, disclosed common car wiper component that consists of power switch, motor, wiper mechanism, wiper rubber, and using fixing spring for pressing wiper rubber against the windscreen glass of the car due to smooth and curved surface of the glass. The patent also disclosed problem related to uneven rubber of the wiper that caused the water to seep through the gap while wiping the rain and the wiper could not wipe off the rain entirely. The gaps were caused by wearing out of the rubber due to heat from the glass when there is no rainfall or when the wiper blade did not press against the wiper rubber constantly. Furthermore, premature fatigue of the spring brings improper spring compression force as the user lift the wiper blade higher than necessary during the parking or when the wiper was not used, making the spring fully and continually stretched. Wherein the said invention disclosed art that solved the problem concerning the aspect improvement of wiper blade lifter that consists of wiper blade lifting mechanism operate with switch or remote control and motor that drive rotating screw shaft to extend or retract the rocker to forcibly lift the wiper blade in predetermined level to extend the lifespan of the wiper rubber and spring when the car is parked or when the wiper is not used. Thus, prevent the problem of not completely wiping off the rain. However, the surface of car windscreen glass is smooth and curved which differ from the surface of skylight windows that is flat throughout the whole part, therefore the new design of wiper beam of automated self-cleaning Skylight according to the present invention is needed.

Thai petty patent application No. 1403001790 filed Dec. 30, 2014, was founded under the title of Window lifting mechanism driven by synchronous belt. The petty patent disclosed art related to synchronous belt mechanism having belt structure with seam within the belt which prevent sliping between belt and hoist, and use electric motor as a movement determinant for circular movement on belt hoist. Wherein window fastening base was attached to synchronous belt. When electric motor rotate, hoist would rotate consequently and window fastening base therefore shifted back and forth to control rotational direction of the electric motor. Wherein the said invention disclosed the need to acquire rail for accurate and smooth movement controlling of the window fastening base.

Thai petty patent application No. 1503000454 filed Mar. 30, 2015, was founded under the title of Solar cell cleaner. The petty patent disclosed the use of water scraper for removing water after washing with window cleaning brush that was installed on secondary beam of the structure and window wiping chamois cloth was installed at the back of the structure, next to the water scraper. Wherein the chamois cloth could be removed for cleaning. Primary beam of the structure was installed with driving parts at the flanges in intervals and was assembled with timing pulleys and pressing hoist to transmit the power to the transmission shaft. Wherein the timing pulley was attached with the wheels for moving on solar cell according to installation aspect. Wherein wheels support the solar cell while moving. Pipe was provided at the secondary beam of the structure, wherein the pipe is aluminum pipe that was drilled in intervals to receive small spray nozzles for thoroughly cleaning. There is limit in the installation aspect of controller for automated control of said invention, which is installed in the similar way as battery box. Controller was installed near the motor side of the flange, while the motor was installed at the end of the cleaner, on the primary beam of the structure. Cleaner may affected by heat from the sun and moisture from rain or water that used for window cleaning. Thus, this invention could not be applied for using in automated self-cleaning skylight of present invention, as the device is permanently installed on primary skylight bearing structure. Wherein the controller cannot be installed on said primary skylight bearing structure to prevent effects from heat from the sun and moisture from rain or water that used for window cleaning. Automated self-cleaning skylight is different from solar cell cleaner of said invention, which move on edge of solar cell according to installation aspect. The cleaner was stored after use and was not permanently installed on solar cell.

### SUMMARY OF THE INVENTION

The present invention is an automated self-cleaning skylight consisting of a frame (1) fitted with a glass (2), at diagonally opposite corners of frame (1) are located with spray nozzles. Wherein the spray nozzles (13) are connected to a tube (14), the tube is used to deliver the cleaning solution by using a pump. Wherein the Motor (4) is installed at the middle on the top side of the frame (1), and it is concealed by a cover. The Motor (4) will be controlled by automatic command of the controller (15). On either side of the motor (4) are connected to the shafts (5), and one side of the shafts (5) is connected to a rotating pulley (6) and the tension pulley (7), located at the base of the skylight frame (1). The mechanism rotates to drive the wiper beam (12) moving along the rails (3) from one edge of the glass to the other edge by the motor (4). Where two wiper blade guide plates (9) are mounted on opposite sides of the frame (1) and move on the rails (3) with two top wheels (10T) and two bottom wheels (10B). The wiper beam (12) fitted with the wiper blades (17). Wherein the wiper blades (17) are inserted into a groove in the wiper beam (12), the wiper blades (17), are locked into place by the wiper beam guide plates (9)

Objective of present invention is automated self-cleaning skylight with new design of wiper beam that could fit the appearance of surface of skylight windows which is flat throughout the whole part. Wherein the wiper beam that moves along the rail can be easily removed and reinstalled from one edge of glass to another edge automatically. Wherein there is automated controller installed indoor to avoid effects of heat from the sun and moisture from rain or water that used for window cleaning.

### BRIEF DESCRIPTION OF DRAWINGS

FIG. 1 shows perspective view of automated self-cleaning skylight according to present invention.

FIG. 2 shows side view of automated self-cleaning skylight according to present invention.

FIG. 3 shows cross-sectional view of wiper beam of automated self-cleaning skylight according to present invention.

### DETAILED DESCRIPTION OF THE INVENTION

An automated self-cleaning skylight, according to the present invention, comprising a frame (1), a glass (2), rails (3), a motor (4), shafts (5), a rotating pulley (6), a tension pulley (7), a drive belt (8), wiper blade guide plates (9), top wheels (10T), bottom wheels (10B), a belt lock (11), a wiper beam (12), spray nozzles (13), a tube (14), a controller (15), a belt drive lock (16), wiper blades (17), and a cover (18) which are detailed as follows.

In reference to FIG. 1, the automated self-cleaning skylight according to the present invention consists of a rectangular frame (1), fitted with glass (2) which shall be installed on a roof or any sidewall of a house or building to let in natural light. Rails (3) are installed on either side of the frame (1) which guides the wiper beam (12). Rails (3) can be permanently installed on the frame (1) or removable.

Spray nozzles (13) have a function to spray the cleaning solution on the glass (2), Spray nozzles (13) are located at diagonally opposite each other on the top corner and bottom corner of the frame (1). Wherein the spray nozzles (13) are connected to a tube (14), the tube is used to deliver the cleaning solution by using a pump, the tube can be made from any material, but the appropriate material is rubber. The cleaning solution is contained in a storage tank located in the controller (15), when a signal is sent from the controller (15) to the pump which is attached to the storage tank, the pump sends the cleaning solution to spray nozzles, the controller (15) connects with the tube on the bottom corner of the frame (1).

Motor (4) is installed at the middle on the top side of the frame (1), and it is concealed by a cover to protect the motor (4) and wiring from the weather. On either side of the motor (4) are connected to the shafts (5), and one side of the shafts (5) is connected to a rotating pulley (6)

When power is applied to the motor, the shaft (5) will be moved by the power of the motor, which turns a rotating pulley (6), simultaneously with the tension pulley (7), causing the drive belt (8) to change position, the mechanism will drive the wiper beam (12), the wiper blade guide plates (9) and the wiper blade (17) along the length of the skylight frame.

Wherein the motor (4) will be controlled by automatic command of the controller (15) which is installed indoors, the mechanism rotates to drive the wiper beam (12) moving along the rails (3) from one edge of the glass to the other edge. Controlling the movement automatically to avoid the damaging effects of the heat from the sun and the moisture from the rain or water that is used for window cleaning.

The mechanism of the automated self-cleaning skylight according to the present invention was newly designed to suit the surface of the skylight glass which is entirely flat.

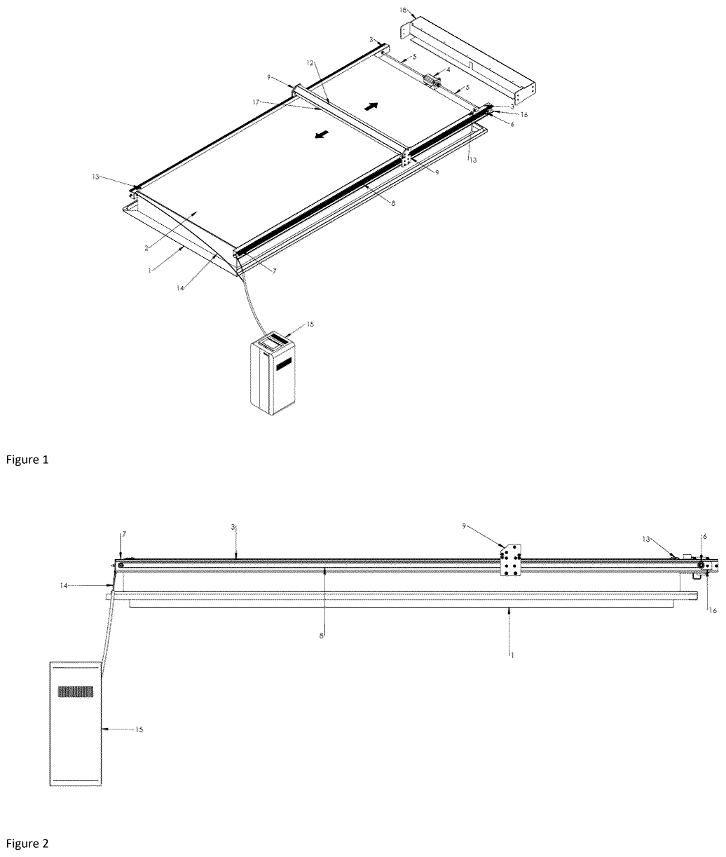

FIG. 2 shows a side view of the automated self-cleaning skylight according to the present invention. On one side of the shafts (5) connects with a rotating pulley (6) and a rotating pulley (6) connects to the drive belt (8) at one end and another end of the drive belt (8) connects with the tension pulley (7). The tension pulley (7), located at the base of the skylight frame (1).

The tension pulley (7) is installed inside of the rails (3), the tension pully (7), is used to apply tension to the drive belt (8), applying tension to the drive belt (8), and adjusted so that the wiper beam (12), operates smoothly.

When a power source is applied, the motor (4), rotates the shaft (5), and rotating pulley (6), this activates the drive belt (8), and the drive belt (8) is moved around the rotating pulley (6) and the tension pulley (7). Therefore, the drive belt (8) can be seen as two belts i.e. the upper belt and the lower belt. There is a belt drive lock (16) installed on top of the drive belt (8), the belt drive lock will secure that the drive belt (8), will does slip off the rotating pulley (6).

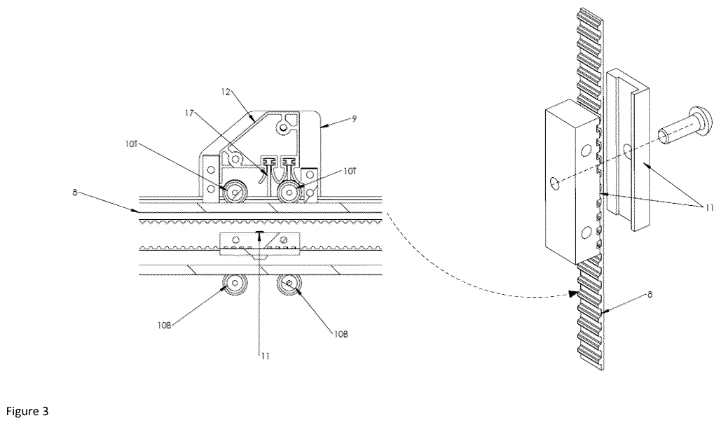

FIG. 3 shows a cross-sectional view of the wiper beam of the automated self-cleaning skylight according to the present invention. The wiper beam (12) consists of two wiper blade guide plates (9), which are attached to the bottom drive belt (8) where the wiper blade guide plates (9) are fixed to the lower drive belt (8) by a drive belt lock (11).

Where two wiper blade guide plates (9) are mounted on opposite sides of the frame (1) and move on the rails (3) with two top wheels (10T) and two bottom wheels (10B). Four wheels connect with the guide in a groove which locks in the two top wheels (10T) and two bottom wheels (10B), and guides to wiper beam (12), across the length of the skylight.

The wiper beam (12) fitted with the wiper blades (17). Wherein the wiper blades (17) are inserted into a groove in the wiper beam (12), the wiper blades (17), are locked into place by the wiper blade guide plates (9)
after the wetting down process is complete, the controller (15), activates the motor (4), the motor (4) drives the shafts (5) and the shafts will turn the rotating pulley (6) simultaneously with the tension pulley (7), and this tension pulley (7), will activate the drive belt (8), which will move the wiper beam (12) the wiper blade guide plates (9) and the wiper blade (17). During the movement, the wiper blade (17) contacts the glass (2), the motion of the wiper blades (17), moving over the glass (2), in combination with the cleaning solution, distributes the cleaning solution along the surface of the glass (2), and moves along the length of the skylight frame (1), cleaning the glass (2), surface. When the wiper beam (12), has traveled the length of the skylight frame (1), the motor (4), will stop and automatically rotate in the opposite direction moving the wiper beam (12), and wiper blade (17), back to the starting position. The wiper blade (17), when returning to the top for the frame (1), pushes the cleaning solution and any dirt, debris off the glass (2), into the frame (1), main drain gutter.

Although this invention is described in its entirety using the attached drawings as examples, it should be understood that any modification or adaptation can be done by one with ordinary skills in the art while remaining within the scope and purpose of this invention. The scope of this invention shall be in accordance with the embodiment of the invention specified in the attached claims. It also covers embodiments of the invention that are not specifically described in the claims yet advantageous with a result similar to the embodiments that are specified in the claims.

1. An automated self-cleaning skylight comprising:
(a) a frame fitted with a glass, wherein at diagonally opposite corners of the frame are located with spray nozzles and the spray nozzles are connected to a tube used to deliver a cleaning solution, and
(b) rails at each side of the frame which guides a wiper beam to move by a motor, wherein the motor is installed on a top side of the frame and is concealed by a cover, and both sides of the motor are connected to shafts,
(c) wherein one side of the shafts is connected to a rotating pulley and a tension pulley, and the tension pulley is located at a base of the frame, wherein the motor rotates to drive the wiper beam to move along the rails from one edge of the glass to an opposite edge through rotating the shaft and wheels of the rotating pulley so as to activate a belt drive to move around the rotating pulley and the tension pulley, and the belt drive is capable of being locked by a belt drive lock installed on top of the belt drive,
(d) wherein the wiper beam comprises two wiper blade guide plates and is attached to a lower part of the belt drive where the wiper blade guide plates are fixed to, and wherein the two wiper blade guide plates are mounted on opposite sides of the frame and moveable on the rails.

2. The automated self-cleaning skylight of claim 1, wherein the wiper blade guide plates are fixed to the lower part of the belt drive by a drive belt lock.

3. The automated self-cleaning skylight of claim 1, wherein the two wiper blade guide plates (9) and moveable on the rails with two top wheels and two bottom wheels.

4. The automated self-cleaning skylight of claim 1, wherein the cleaning solution is delivered by using a pump and is sprayed via the spray nozzles.

5. The automated self-cleaning skylight of claim 1, wherein the motor is controlled by an automatic command of a controller.

6. The automated self-cleaning skylight of claim 1, wherein the wiper beam has a length equal to a width of the glass.

7. The automated self-cleaning skylight of claim 1, wherein wiper blades are inserted into a groove in the wiper beam, and the wiper blades are secured at a fixed position by the wiper blade guide plates.
